(19) United States
(12) Patent Application Publication
(10) Pub. No.: US 2010/0217763 A1
(43) Pub. Date: Aug. 26, 2010

(54) METHOD FOR AUTOMATIC CLUSTERING AND METHOD AND APPARATUS FOR MULTIPATH CLUSTERING IN WIRELESS COMMUNICATION USING THE SAME

(75) Inventors: Jae Joon Park, Daejeon (KR); Won Sop Kim, Daejeon (KR); Myung Don Kim, Daejeon (KR); Hyun Kyu Chung, Daejeon (KR); Seong-Cheol Kim, Seoul (KR); Ja-ho Koo, Seoul (KR); Namkoo Kang, Gyeonggi-do (KR)

Correspondence Address: LADAS & PARRY LLP, 224 SOUTH MICHIGAN AVENUE, SUITE 1600, CHICAGO, IL, 60604, US

(73) Assignees: ELECTRONICS AND TELECOMMUNICATIONS RESEARCH INSTITUTE, Daejeon (KR); SEOUL NATIONAL UNIVERSITY INDUSTRY FOUNDATION, Seoul (KR)

(21) Appl. No.: 12/678,545

(22) PCT Filed: May 19, 2008
(86) PCT No.: PCT/KR2008/002782

§ 371 Date: Mar. 17, 2010

(30) Foreign Application Priority Data
Sep. 17, 2007 (KR) 10-2007-0094116

(51) Int. Cl. G06F 17/30

(52) U.S. Cl. 707/737; 707/E17.089; 707/741; 707/E17.002

(57) ABSTRACT

An automatic clustering method using an Average-linkage algorithm and a KPower Means algorithm, and a method and apparatus for multi-path clustering required for a spatial channel modeling (SCM) in a wireless communication environment are provided. The automatic clustering method, including: a first step of obtaining an initial cluster centroid using a hierarchical clustering algorithm; a second step of moving the initial cluster centroid using a two dimensional clustering algorithm; a third step of clustering a data set according to the moved initial cluster centroid; and a fourth step of calculating a validation index with respect to the clustered data set and determining an optimal number of clusters.

### TECHNICAL FIELD

The present invention relates to an automatic clustering method, and more particularly, to an automatic clustering method using an Average-linkage algorithm and a KPower Means algorithm, and a method and apparatus for multi-path clustering required for a spatial channel modeling in a wireless communication environment.

This work was supported by the IT R&D program of MIC/IITA. [2005-S-001-03, Development of wireless vector channel model for next generation mobile communication]

### BACKGROUND ART

Due to the increase in wireless communication service and a variety of requirements, much research on high speed wireless transmission, efficient frequency use, and multi-antenna transmission have been conducted. For this, wireless channel characteristics are required to be ascertained.

A measurement system to ascertain wireless channel characteristics is a system for measuring characteristics of a multiple-input multiple-output (MIMO) channel. The measurement system analyzes characteristics of radio waves of a frequency band in a next generation wireless communication, and is used for channel modeling that must be performed to use the frequency band.

A next generation wireless communication system requires a broad bandwidth for high speed wireless data transmission and efficient frequency use. Also, a next generation wireless communication system is designed to measure a wideband spatial channel of 100 MHz, as opposed to a narrowband channel, for channel modeling. Accordingly, a broadband radio frequency (RF) module, high speed analog-to-digital converter (ADC), and baseband signal processing technologies, used for a broadband signal processing, are reflected in the design.

FIG. 1 is a diagram illustrating a configuration of a multi-path transceiving system in a wireless communication environment in a conventional art.

As illustrated in FIG. 1, a channel characteristics analysis device 140, hereinafter, measurement system 140, is designed to sequentially transceive a measurement signal and load measurement signals using an external control personal computer (PC) 150 to support various measurement signals. Four transmitting antennas 110 and eight receiving antennas 120 enabling an MIMO channel to be measured are used for the sequential transceiving. Also, wireless spatial channel measurement data is stored in an external storage device, and various characteristics of a wireless spatial channel, for example, impulse response, scattering function, power delay profile, and Doppler power spectrum, are analyzed by post-processing.

The present invention relates to a multi-path clustering using the data, measured by the measurement system 140, with respect to a wireless spatial channel analysis in the wireless communication environment. Also, an automatic clustering algorithm and standard for multi-path clustering are provided.

Due to the development of wireless communication, greater capacity is required, and a space division multiple access (SDMA) scheme is developed to meet the requirement. An SDMA allocates much communication resources to users that are located in other places but belong to a single station by using a beam-forming technology using a multiple array antenna. As an interest in an array antenna increases, channel characteristics analysis in a time domain as well as a space domain is critical. A spatial channel modeling (SCM) is required to use an SDMA scheme. An SCM ascertaining an angle of arrival which is a characteristic of a multi-path signal has been studied using an array signal processing method and array antenna.

An array signal processing method to find an angle of arrival using a signal received in an array antenna includes a Space Alternating Generalized Expectation Maximization (SAGE) algorithm. A channel parameter may be estimated using an SAGE algorithm, and research on how to perform an SCM based on the estimated channel parameter has been conducted. However, since the channel parameter through an SAGE algorithm has no cluster information indicating a similarity of each multi-path, clustering is required for SCM.

Clustering has been performed with the naked eye. However, as an amount of measurement data increases and an amount of required channel parameter information increases, a clustering by a macrography is not efficient.

Currently, research on a semi-automatic clustering method has been conducted, and an automatic KPowerMeans algorithm has been provided.

However, disadvantages such as a performance degradation due to an initial cluster centroid and difficulty in optimization for a wireless communication environment exist. Accordingly, an optimized automatic clustering algorithm using a channel parameter in a wireless communication environment is required.

### DISCLOSURE OF INVENTION

### Technical Problem

The present invention provides an automatic clustering method which sets an initial cluster centroid using a hierarchical clustering algorithm, and thereby may overcome a performance degradation due to the initial cluster centroid.

The present invention also provides a method and apparatus for multi-path clustering for a wireless communication environment by using an automatic clustering method which may overcome a performance degradation due to an initial cluster centroid.

### Technical Solution

According to an aspect of the present invention, there is provided an automatic clustering method, including: a first step of obtaining an initial cluster centroid using a hierarchical clustering algorithm; a second step of moving the initial cluster centroid using a two dimensional clustering algorithm; a third step of clustering a data set according to the moved initial cluster centroid; and a fourth step of calculating a validation index with respect to the clustered data set and determining an optimal number of clusters.

Specifically, the fourth step includes: performing the first step, second step, and third step with respect to each value from an initial value to a maximum value of a previously set number of clusters and obtaining each of the clustered data sets; calculating a validation index with respect to each of the clustered data sets; and determining a number of clusters when the validation index is maximum as an optimal number of clusters.

According to an aspect of the present invention, there is provided a method of multi-path clustering in a wireless communication environment, the method including: determining a weight of a channel parameter for a distance calculation of a multi-path component; applying the determined weight of the channel parameter to a hierarchical clustering algorithm; calculating a centroid of a cluster using the hierarchical clustering algorithm; setting the calculated centroid of the cluster as an initial cluster centroid and executing a KPowerMeans algorithm; calculating a validation index with respect to a result of the executing; and determining an optimal number of clusters according to the calculated validation index.

According to an aspect of the present invention, there is provided an apparatus for multi-path clustering in a wireless communication environment, the apparatus including: a data storage unit to store a multi-path component, channel parameter, and weight information about the channel parameter which are received via a multi-path; a clustering algorithm execution unit to apply a hierarchical clustering algorithm with respect to the multi-path component, set an initial cluster centroid, move the initial cluster centroid using a KPowerMeans algorithm, and execute a clustering; and a cluster number determination unit to calculate a validation index with respect to the executed clustering, and determine an optimal number of clusters based on the calculated validation index.

### BRIEF DESCRIPTION OF THE DRAWINGS

FIG. 1 is a diagram illustrating a configuration of a multi-path transceiving system in a wireless communication environment in a conventional art;

FIG. 2 is a block diagram illustrating an apparatus for multi-path clustering according to an embodiment of the present invention;

FIG. 3 is a flowchart illustrating an automatic clustering method according to an embodiment of the present invention;

FIG. 4 is a flowchart illustrating a method of multi-path clustering in a wireless communication environment according to an embodiment of the present invention;

FIG. 5 is a graph illustrating performances of clustering algorithms according to an angular spread change in a cluster in a wireless communication environment;

FIG. 6 is a graphs illustrating performances of clustering algorithms according to a change in a delay spread (DS).

### MODE FOR THE INVENTION

Hereinafter, embodiments of the present invention are described in detail by referring to the figures.

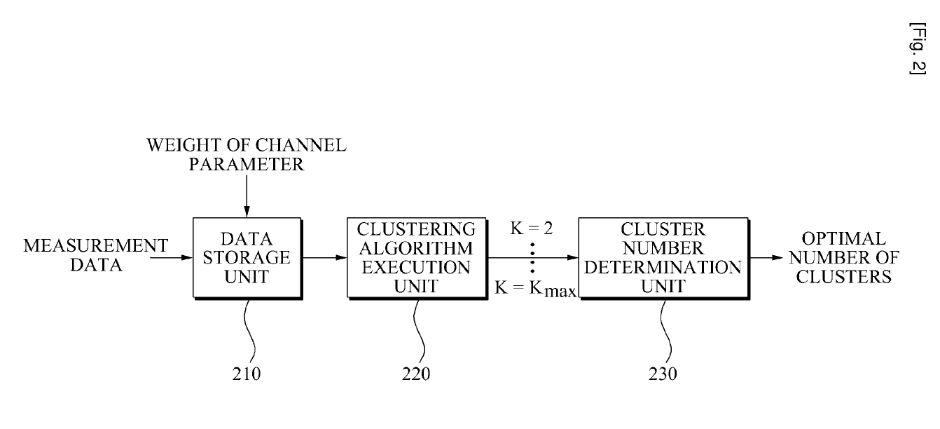

FIG. 2 is a block diagram illustrating an apparatus for multi-path clustering according to an embodiment of the present invention.

Referring to FIG. 2, the apparatus for multi-path clustering includes a data storage unit 210, a clustering algorithm execution unit 220, and a cluster number determination unit 230. The data storage unit 210 stores a multi-path component (MPC), channel parameter, and weight information about the channel parameter which are received via a multi-path. The clustering algorithm execution unit 220 applies a hierarchical clustering algorithm with respect to the MPC, sets an initial cluster centroid, moves the initial cluster centroid using a KPowerMeans algorithm, and executes a clustering. The cluster number determination unit 230 calculates a validation index with respect to the executed clustering, and determines an optimal number of clusters based on the calculated validation index.

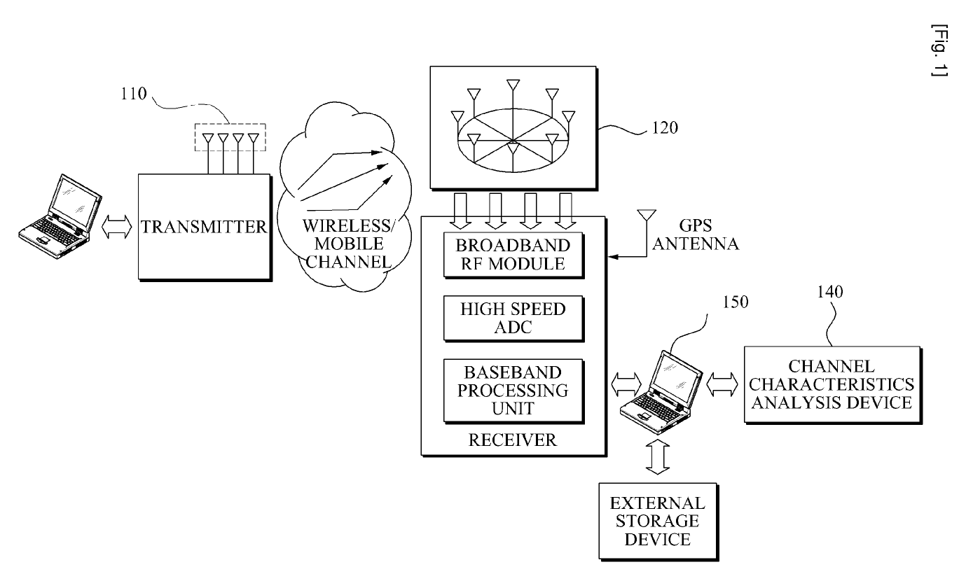

The data storage unit 210 stores the weight of the channel parameter and various measurement data. The measurement data is measured by a multiple-input multiple output (MIMO) system illustrated in FIG. 1. The weight of the channel parameter is determined according to an experiment which is described in the present specification.

That is, the weight of the channel parameter has a delay scaling factor of 10 and an angular scaling factor of 0.5 when a delay, angle of arrival, and angle of departure are used as the channel parameter.

Also, the weight of the channel parameter has a delay scaling factor of 10 and an angular scaling factor of 0.7 when delay and angle of departure are used as the channel parameter.

The clustering algorithm execution unit 220 performs an automatic clustering algorithm where an Average-linkage algorithm and KPowerMeans algorithm are combined, and executes a clustering with respect to MPCs.

The cluster number determination unit 230 performs the automatic clustering algorithm with respect to each of an initial number of clusters (K=2) to a maximum number of clusters (K=Kₘₐₓ), and calculates a Calinski-Harabasz (CH) index with respect to each result. A number of clusters, K, when the CH index is maximum is determined as an optimal number of clusters.

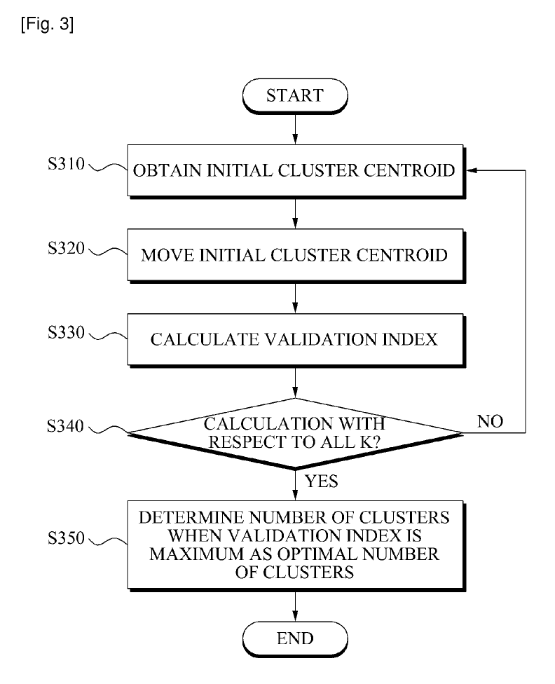

FIG. 3 is a flowchart illustrating an automatic clustering method according to an embodiment of the present invention.

Referring to FIG. 3, the automatic clustering method includes obtaining an initial cluster centroid using a hierarchical clustering algorithm in operation S310, moving the initial cluster centroid using a two dimensional clustering algorithm and clustering a data set according to the moved initial cluster centroid in operation S320, calculating a validation index with respect to the clustered data set in operation S330, and determining an optimal number of clusters in operations S340 and S350.

Specifically, in operation S310, the clustering algorithm execution unit 220 calculates the initial cluster centroid of the two dimensional clustering algorithm such as a KPowerMeans algorithm, using the hierarchical clustering algorithm such as an Average-linkage algorithm.

In operation S320, the clustering algorithm execution unit 220 performs the two dimensional clustering algorithm and moves the initial cluster centroid. Input data is included in each cluster having the moved initial cluster centroid according to the executing of the two dimensional clustering algorithm.

In operation S330, the cluster number determination unit 230 calculates the validation index with respect to a result of the executing. For example, a CH index is used as the validation index.

In operation S340, the cluster number determination unit 230 stores the CH index, and determines whether the obtaining in operation S310, the moving in operation S320, and the calculating in operation S330 are performed with respect to every available number of clusters.

In operation S350, when a result of the determining in operation S340 is ‘yes’, a number of clusters when the validation index is maximum is determined as an optimal number of clusters.

Hereinafter, a method of multi-path clustering in a wireless communication environment according to an embodiment of the present invention is described in detail.

According to the present invention, an optimal automatic clustering method in a wireless communication environment is provided based on a result of comparing a single-linkage, average-linkage, K-means, KPowerMeans, and fuzzy c-means (FCM) clustering algorithms with other clustering validation techniques in order to overcome a disadvantage of clustering using macrography and provide a method of multi-path clustering for a wireless communication environment. An analysis of clustering algorithm performance is based on data provided by a 3^{rd} generation partnership project (3GPP) spatial channel modeling (SCM). In this instance, a number of clusters and information about a path in a cluster may be previously ascertained using the data, and thus a weight of delay and angle of arrival of a multi-path component distance (MCD) may be determined. The MCD is a distance function of clustering algorithm.

Also, according to the present invention, an optimal automatic clustering method in a wireless communication environment is provided based on a result of executing a clustering with respect to various delay spreads (DSs) and 3GPP SCM data of angular spread. In this instance, a single-linkage, average-linkage, K-means, KPowerMeans, and FCM clustering algorithm and a CH, Davies-Bouldin (DB), Index I, CombinedValidate (CV), Xie-Beni (XB), and Dunn's index clustering validation techniques are used.

In a K-means algorithm in a conventional art, an initial cluster centroid is arbitrarily selected from MPCs in order to execute a clustering. Accordingly, every time the clustering is executed, different values are obtained, which results in a degradation of performance.

However, according to an embodiment of the present invention, a disadvantage associated with the initial cluster centroid is overcome through the average-linkage algorithm which may quickly perform calculations. In the average-linkage algorithm, each MPC is serially combined from an initial cluster, and thus adjacent clusters may be recognized as a single cluster. In the K-means algorithm, a centroid is repeatedly updated, and thus clustering is performed based on a cluster centroid, and the disadvantage of the average-linkage algorithm may be overcome.

According to the present invention, the disadvantage of the average-linkage algorithm and the K-means algorithm may be overcome.

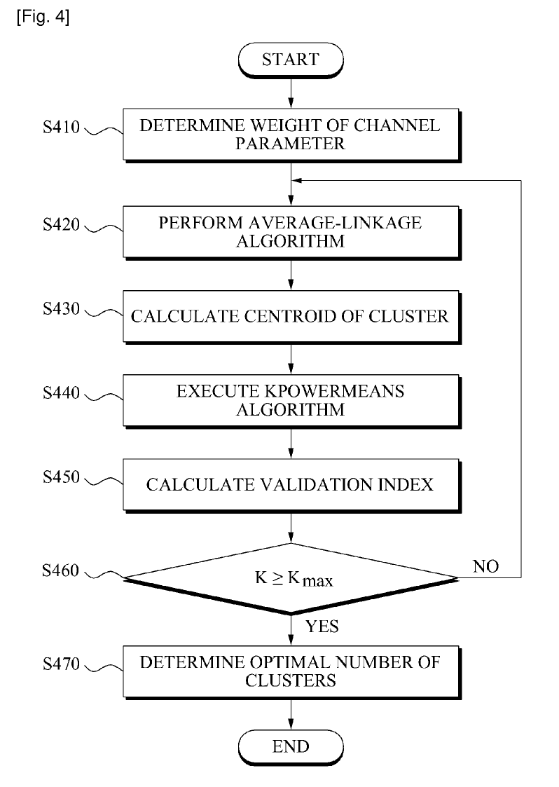

FIG. 4 is a flowchart illustrating a method of multi-path clustering in a wireless communication environment according to an embodiment of the present invention.

Referring to FIG. 4, the method of multi-path clustering includes determining a weight of a channel parameter for a distance calculation of a multi-path component in operation S410, applying the determined weight of the channel parameter to a hierarchical clustering algorithm such as an Average-linkage algorithm in operation S420, calculating a centroid of a cluster using the hierarchical clustering algorithm in operation S430, setting the calculated centroid of the cluster as an initial cluster centroid of a two dimensional clustering such as a KPowerMeans algorithm and executing the KPowerMeans algorithm in operation S440, calculating a validation index with respect to a result of the executing in operation S450, determining whether the above operations in operations S410 through S450 are performed with respect to an available number of clusters in operation S460, and determining an optimal number of clusters according to the calculated validation index in operation S470.

Hereinafter, the method of multi-path clustering illustrated in FIG. 4 is described in detail.

<Determining a Weight of a Channel Parameter in Operation S410>

A configuration of MPC where a clustering algorithm for calculating an MCD is inputted is as follows.

A single window datum includes an L number of MPCs. Each MPC includes a vector indicating power

Pₗ, l=1 . . . L

and a parameter vector X₁. The parameter vector X₁ includes a delay τ, azimuth AoA

φ_{AoA}

, elevation AoA

θAoA

, azimuth AoD

φ_{AoD}

, and elevation AoD

θ_{AoD}

.

The MCD is a distance function enabling path information having different units to be jointly processed.

The angle parameters, AoA and AoD, of the MCD are defined as,

$$\begin{matrix}{MCD}_{AoA / AoD , ij} = \frac{1}{2} δ \cdot \vert \begin{matrix}( \begin{matrix}sin ( {θ}_{i} ) cos ( {ϕ}_{i} ) \\ sin ( {θ}_{i} ) sin ( {ϕ}_{i} ) \\ cos ( {θ}_{i} )\end{matrix} ) - \\ ( \begin{matrix}sin ( {θ}_{j} ) cos ( {ϕ}_{j} ) \\ sin ( {θ}_{j} ) sin ( {ϕ}_{j} ) \\ cos ( {θ}_{j} )\end{matrix} )\end{matrix} \vert \\ δ \text{:} angular scaling factor .\end{matrix} \qquad [ Equation 1 ]$$

Also, an MCD with respect to the delay parameter is represented as,

$$\begin{matrix}{MCD}_{τ , ij} = ζ \cdot \frac{\vert {τ}_{i} - {τ}_{j} \vert}{Δ {τ}_{max}} \cdot \frac{{τ}_{std}}{{Δτ}_{max}} \\ Δ {τ}_{max} = {max}_{i , j} \{ \vert {τ}_{i} - {τ}_{j} \vert \} , ζ \text{:} delay scaling factor .\end{matrix} \qquad [ Equation 2 ]$$

The distance function of the MCD is defined as,

$${MCD}_{ij} = \sqrt{\begin{matrix}{‖ {MCD}_{AoA , ij} ‖}^{2} + \\ {‖ {MCD}_{AoD , ij} ‖}^{2} + \\ {MCD}_{τ , ij}^{2}\end{matrix}} . \qquad [ Equation 3 ]$$

Here, i and j of Equation 1, Equation 2, and Equation 3 are indexes of MPC, respectively.

The delay is a most significant factor when performing a clustering. Since various angular spreads occur according to a communication environment, an appropriate weight of the MCD, that is, the weight of the channel parameter, is required to be determined to apply a clustering algorithm. In the present invention, multiple-input multiple-output (MIMO) channel data obtained from a 3GPP SCM is used to determine the weight of the channel parameter. A data set provided by the 3GPP SCM has a same delay in each cluster and a predetermined angular spread in each of the clusters.

However, in an actual communication environment, the same delay may not be formed, and various angular spreads occur depending on the communication environment. Thus, according to the present invention, a DS and angular spread in a cluster of a previously generated data set are arbitrarily changed to perform a simulation.

As a result of the simulation, when a delay, angle of arrival, and angle of departure are used as the channel parameter, a delay scaling factor is 10 and an angular scaling factor is 0.5. Also, when the delay and angle of arrival are used as the channel parameter, a delay scaling factor is 10 and an angular scaling factor is 0.7. The result of the simulation is illustrated in FIGS. 2 and 3.

<Performing an Average-Linkage Algorithm with Respect to Input Data in Operation S420>

In operation S420, the initial cluster centroid of the two dimensional clustering is calculated.

The Average-linkage algorithm is the hierarchical clustering algorithm, and defines a distance between two clusters as an average distance among samples in each cluster. A hierarchical clustering is an operation for forming a large group including a number of small groups of data. Each data sample at a root forms a single cluster. Accordingly, the single cluster is clustered into two groups by the distance calculation among the samples through the Average-linkage algorithm when a number of clusters is two.

In the Average-linkage algorithm, when an number of samples exist in an index with respect to the clustered group i, Cᵢ, and an nⱼ number of samples exist in an index with respect to the clustered group j, Cⱼ, the distance between the two clusters are defined as,

$${D}_{AL} ( {C}_{i} , {C}_{j} ) = \frac{1}{{n}_{i} {n}_{j}} {\sum }_{a ∈ {C}_{i} , a ∈ {C}_{j}} MCD ( a , b ) . \qquad [ Equation 4 ]$$

<Calculating a Centroid of a Cluster in Operation S430>

According to the present invention, the initial cluster centroid of the KPowerMeans algorithm is determined using the Average-linkage algorithm.

The number of initial clusters is two, and a centroid of each of the two clusters clustered by the Average-linkage algorithm is calculated by,

$${c}_{k}^{( i )} = \frac{{\sum }_{j ∈ {c}_{k}^{( i )}} ( {P}_{j} \cdot {x}_{j} )}{{\sum }_{j ∈ {c}_{k}^{( i )}} {P}_{j}} . \qquad [ Equation 5 ]$$

where Pⱼ is power of a j-th MPC, and xⱼ is a parameter vector of the j-th MPC.

<Executing a KPowerMeans Algorithm in Operation S440>

According to the present invention, each of the centroids of the two clusters calculated by Equation 5 is set as the initial cluster centroid, and the KPowerMeans algorithm is executed.

The KPowerMeans algorithm performs a clustering according to a number of provided clusters.

A K-Means algorithm two dimensionally performs the clustering without considering a hierarchy of clusters. The K-Means algorithm partitions a provided data set according to a predetermined number of clusters. The number of clusters, K, is inputted and the K is referred to as a seed point. The seed point is arbitrarily selected from MPCs of an entire data set, and the selected MPC is the initial cluster centroid. Each of the selected MPCs belongs to a cluster having a cluster centroid closest to each of the selected MPCs.

The K-Means algorithm is iteratively performed so that an entire sum of distances between each of the cluster centroids and the MPC belonging to each of the clusters is minimal. The entire sum is defined as,

$$D = {\sum }_{l = 1}^{L} MCD ( {x}_{l ,} {c}_{{x}_{l}} ) \qquad [ Equation 6 ]$$

where L is a number of MPCs, x₁ is a parameter vector of a first MPC, and Cx₁ is a parameter of a cluster centroid closest to the first MPC.

In the K-Means algorithm, the cluster centroid is moved to an intermediate value of the MPC while iterating through the K-Means algorithm, and the clustering is performed with respect to the again moved cluster centroid. The K-Means algorithm is repeatedly iterated through until the cluster centroid no longer moves.

The KPowerMeans algorithm applies a power weight to an existing K-means algorithm for an efficient clustering in a communication environment.

The KPowerMeans algorithm is iteratively performed so that an entire sum of distances between each of the cluster centroids and the MPC belonging to the each of the clusters is minimal considering the power weight. The entire sum considering the power weight is defined as,

$$D = {\sum }_{l = 1}^{L} {P}_{l} \cdot MCD ( {x}_{l} , {c}_{{x}_{l}} ) , \qquad [ Equation 7 ]$$

where P/is power of the first MPC.

The cluster centroid is iteratively, that is, from K=2 to K=Kₘₐₓ times, moved by,

$${c}_{k}^{( i )} = \frac{{\sum }_{j ∈ {c}_{k}^{( i )}} ( {P}_{j} \cdot {x}_{j} )}{{\sum }_{j ∈ {c}_{k}^{( i )}} {P}_{j}} . \qquad [ Equation 8 ]$$

A number of clusters to execute the KPowerMeans algorithm corresponds to K=2 to K=Kₘₐₓ which is a square root of a number of multi-paths received in a single snapshot.

<Calculating a Validation Index in Operation S450>

The validation index showing an optimal performance when a variety of clustering algorithms are applied with respect to various 3GPP SCM data is the CH index. A cluster algorithm basically receives a number of clusters, separate from data.

However, it is critical to ascertain a number of clusters according to the provided data and obtain cluster information of each of the MPCs. Accordingly, the validation index is required to determine the optimal number of clusters. A cluster validation method is mainly defined by two distance functions.

The two distance functions are δ(Cᵢ,Cⱼ)

which is an inter-cluster distance and

Δ(Cₖ)

which is an intra-cluster distance. The inter-cluster distance indicates a separation of each cluster, and the intra-cluster distance indicates a compactness of MPCs of each of the clusters. The cluster validation method generally obtains the optimal number of clusters having a great separation and a minimum compactness.

When an L number of MPCs are clustered into a K number of clusters, the CH index is defined by Equation 9 and Equation 10:

$$CH ( K ) = \frac{trace ( B ) / ( K - 1 )}{trace ( W ) / ( L - K )} , \qquad [ Equation 9 ]$$

where B is a scatter matrix between clusters, and W is a scatter matrix in a cluster.

$$\begin{matrix}tr ( B ) = {\sum }_{k = 1}^{K} {L}_{k} \cdot {MCD ( {c}_{k} , \overline{c} )}^{2} \\ tr ( W ) = {\sum }_{k = 1}^{K} {\sum }_{j ∈ {C}_{k}} {MCD ( {x}_{j} , {c}_{k} )}^{2}\end{matrix} \qquad [ Equation 10 ]$$

where Lₖ is a number of MPCs belonging to a kₜₕ cluster, and

c̅

is a global centroid of an entire data set.

The global centroid is defined by,

$$\overline{c} = \frac{{\sum }_{l = 1}^{L} ( {P}_{l} \cdot {x}_{l} )}{{\sum }_{l = 1}^{L} {P}_{l}} . \qquad [ Equation 11 ]$$

<Calculating a CH Index with Respect to an Available Number of Clusters in Operation S460 and Determining an Optimal Number of Clusters in Operation S470>

In the clustering algorithm where the Average-linkage algorithm and the KPowerMeans algorithm are combined, the CH index is calculated with respect to various numbers of clusters, that is, K values, and then a K value enabling the CH index to be maximum is determined as the optimal number of clusters. The clustering algorithm is represented as,

$${K}_{CH} = {ar g max}_{K} \{ CH ( K ) \} \qquad [ Equation 12 ]$$

That is, according to the present invention, the method of multi-path clustering iteratively performs operations S410 through S470 with respect to the available numbers of clusters, and thus the optimal number of clusters and information about the MPC in the cluster according to the optimal number of clusters may be ascertained. A spatial channel characteristics analysis may be performed using the optimal number of clusters and the information.

Hereinafter, a clustering algorithm according to the present invention and a clustering algorithm in a conventional art are compared in a wireless communication environment.

<Performance Comparison of Clustering Algorithms>

First, a weight of an MCD is determined according to a type of channel parameters to compare performances of clustering algorithms. The channel parameter includes a data file.

Then, in order to compare the performances, a clustering with respect to various DSs and 3GPP SCM data of angular spread is performed using a single-linkage, average-linkage, K-means, KPowerMeans, and FCM clustering algorithm together with a CH, DB, Index I, CV, XB, and Dunn's index clustering validation techniques.

A data set generated by a 3GPP SCM has six clusters and one hundred twenty MPCs belonging to the clusters, which is fixed. Accordingly, a proportion of a number of MPCs belonging to an appropriate cluster from among the one hundred twenty MPCs may be obtained. In the present invention, a simulation with respect to at least one hundred data sets of each of angular spreads and DSs is performed with respect to each of the clustering methods described above.

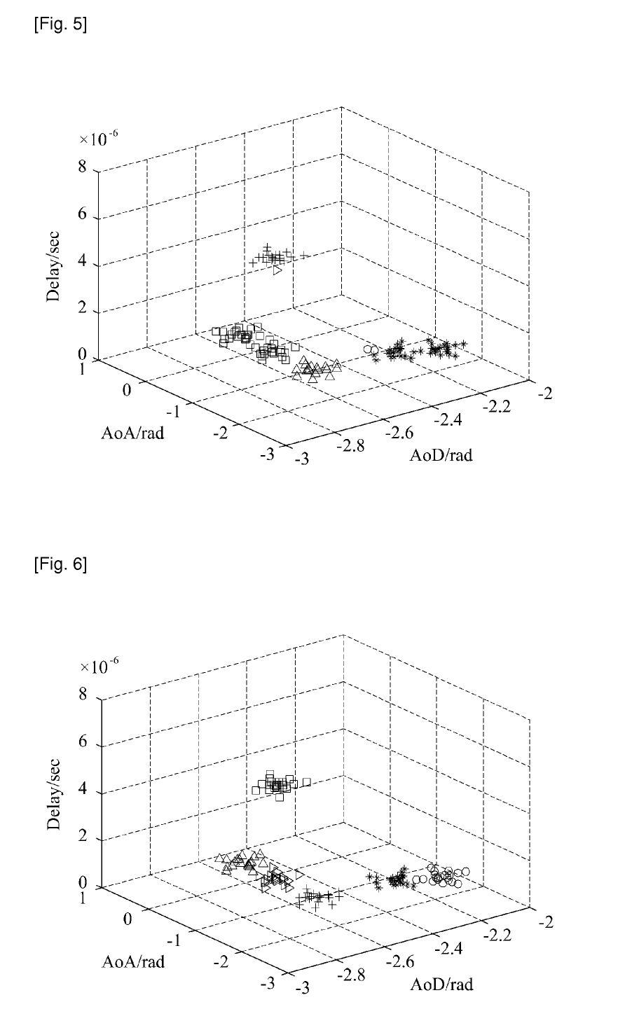

FIG. 5 is a graph illustrating performances of clustering algorithms according to an angular spread change in a cluster in a wireless communication environment.

FIG. 6 is a graph illustrating performances of clustering algorithms according to a change in a DS due to a fixed arrival angle spread.

In FIGS. 5 and 6, an SL refers to a single-linkage algorithm, an AL refers to an Average-linkage algorithm, and a FCMₚ indicates that a power weight is added when calculating a cluster centroid in a FCM algorithm in a conventional art. As illustrated, determining an initial cluster centroid using the SL and AL is superior to a K-means algorithm which arbitrarily determines the initial cluster centroid. Also, the K-means algorithm generates slightly different initial cluster centroids every time the K-means algorithm is performed. However, the above disadvantage may be overcome when an initial cluster centroid is processed by using a linkage algorithm.

<Performance Comparison of Clustering Validation Techniques>

A clustering algorithm receives a data set as well as information about a number of clusters, K. However, the number of clusters with respect to the data set may not be previously determined, and thus a validation technique is required to obtain an optimal number of clusters. A simulation to efficiently obtain the optimal number of clusters is performed using various clustering validation techniques and algorithms. Performances with respect to various angular spreads and DSs in a cluster are compared with the simulation implemented above.

In Table 1 through Table 5, performances of the clustering validation techniques with respect to the various algorithms are compared.

TABLE 1

| | | | | | | | Kpower- | Kpower- | |
|---|---|---|---|---|---|---|---|---|---|
| | | | | | | K-means | means | means | |
| | | SL | SL_P | AL_P | K-means | (SL) | (SL) | (AL) | FCM |
| Per-path | CH (%) | 91.4 | 91.4 | 91.4 | 26.5 | 93.9 | 93.9 | 93.9 | 59.2 |
| AoA | DB | 46.9 | 46.9 | 46.9 | 14.3 | 46.9 | 46.9 | 46.9 | 36.7 |
| AS = 7.7 | CV | 81.6 | 81.6 | 81.6 | 26.5 | 83.7 | 83.7 | 83.7 | 46.9 |
| | Dunn | | 46.9 | 46.9 | 10.2 | | 38.8 | 38.8 | |
| | Index I | | | | | | | | 18.4 |
| | XB | | | | | | | | 20.4 |
| Per-path | CH | 81.8 | 81.8 | 88 | 24 | 81.8 | 81.8 | 90 | 42.4 |
| AoA | DB | 36.4 | 33.6 | 36.4 | 9.1 | 39.4 | 36.4 | 33.3 | 30.3 |
| AS = 12 | CV | 75.8 | 75.8 | 84.8 | 42.4 | 78.8 | 78.8 | 87.9 | 36.4 |
| | Dunn | | 39.4 | 39.4 | 0 | | 18.2 | 18.2 | |
| | Index I | | | | | | | | 42.4 |
| | XB | | | | | | | | 12.1 |
| Per-path | CH | 70.6 | 72.5 | 70.6 | 31.3 | 74.5 | 76.5 | 78.3 | 27.5 |
| AoA | DB | 15.7 | 15.7 | 21.6 | 0 | 16.7 | 19.6 | 19.4 | 7.8 |
| AS = 18 | CV | 49 | 45 | 43.1 | 23.3 | 63.3 | 54.9 | 59.7 | 21.6 |
| | Dunn | | 2.0 | 2.0 | 0 | | 2.0 | 2.0 | |
| | Index I | | | | | | | | 11.8 |
| | XB | | | | | | | | |
| Per-path | CH | 50.2 | 55 | 57.4 | 27.6 | 58.6 | 63.3 | 65.7 | 39.5 |
| AoA | DB | 14.5 | 14.5 | 12.1 | 7.4 | 8.6 | 19.3 | 24.8 | 16.9 |
| AS = 24 | CV | 40.7 | 43.1 | 49.0 | 13.3 | 36.0 | 44.3 | 59.8 | 26.4 |
| | Dunn | | 8.3 | 8.3 | 0 | | 2.8 | 2.8 | |
| | Index I | | | | | | | | 14.5 |
| | XB | | | | | | | | 6.2 |
| Per-path | CH | 35 | 40 | 55 | 25 | 55 | 55 | 58 | 40 |
| AoA | DB | 5 | 5 | 5 | 10 | 25 | 10 | 15 | 5 |
| AS = 36 | CV | 40 | 35 | 50 | 40 | 45 | 45 | 52 | 35 |
| | Index I | 5 | | | | | 0 | | 10 |

In Table 1, the performances of the clustering validation techniques and the various clustering algorithms with respect to the change in the arrival angle spread in the cluster are compared.

TABLE 2

| Per-path AoA AS(Degree) | mean cluster No. | std cluster No. |
|---|---|---|
| 7.7 | 5.92 | 0.61 |
| 12 | 5.91 | 0.51 |
| 18 | 5.79 | 0.43 |
| 24 | 5.36 | 1.07 |
| 36 | 5.45 | 1.23 |

In Table 2, the performances of the clustering validation techniques and the various clustering algorithms with respect to the change in the arrival angle spread in the cluster are compared.

TABLE 3-1

| | | Algorithm | | | | | | | |
|---|---|---|---|---|---|---|---|---|---|
| | | | | | | | Kpower- | Kpower- | |
| | | | | | | K-means | measn | means | |
| | validation | SL | SL_P | AL_P | K-means | SL | (SL) | (AL) | FCM |
| Per-path | CH | 84.7 | 83.4 | 82.1 | 38.0 | 87.3 | 86 | 88.6 | 62.6 |
| AoA | DB | 61.4 | 57.5 | 57.5 | 15.4 | 43.6 | 56.2 | 56.2 | 45.8 |
| AS = 9 | CV | 71.7 | 71.7 | 74.3 | 18.0 | 61.5 | 76.9 | 79.5 | 54.9 |
| DS = 0 | Dunn | | 63.3 | 63.3 | 14.6 | | 65.8 | 53 | |
| | Index_I | | | | | | | | 66.5 |
| | XB | | | | | | | | 32.8 |
| Per-path | CH | 81.2 | 78.7 | 78.7 | 27.4 | 86.4 | 83.8 | 86.4 | 58.2 |
| AoA | DB | 53.0 | 50.0 | 55.6 | 7.7 | 35.9 | 47.9 | 53 | 47.9 |
| AS = 9 | CV | 63.3 | 63.3 | 68.4 | 15.4 | 61.5 | 73.5 | 76.1 | 53 |
| DS = | Dunn | | 60.7 | 60.7 | 17.1 | | 58.2 | 47.9 | |
| 10 ns | Index_I | | | | | | | | 53 |
| | XB | | | | | | | | 29.9 |
| Per-path | CH | 81.2 | 78.7 | 78.7 | 27.4 | 86.4 | 83.8 | 86.4 | 58.2 |
| AoA | DB | 53.0 | 53.0 | 55.6 | 12.8 | 33.3 | 47.9 | 50.5 | 47.9 |
| AS = 9 | CV | 58.2 | 60.7 | 60.7 | 20.5 | 59 | 71 | 73.5 | 58.2 |
| DS = | Dunn | | 53 | 53 | 14.6 | | 55.6 | 47.9 | |
| 20 ns | Index_I | 14.6 | | | | | 17.1 | | 47.9 |
| | XB | | | | | | | | 32.5 |
| Per-path | CH | 73.5 | 71.0 | 71.0 | 32.5 | 78.7 | 81.2 | 81.2 | 40.2 |
| AoA | DB | 53.0 | 50.5 | 53.0 | 7.7 | 33.3 | 42.8 | 50.5 | 37.6 |
| TABLE 3-2 | | | | | | | | | |
| Per-path | CH | 26.1 | 25 | 45.7 | 30.4 | 35.9 | 40.2 | 55.3 | 21.7 |
| AoA | DB | 1.1 | 1.1 | 1.1 | 3.3 | 3.3 | 6.5 | 6.5 | 5.4 |
| AS = 18 | CV | 21.7 | 20.7 | 37.0 | 26.7 | 36.7 | 31.5 | 45.7 | 30.4 |
| DS = | Dunn | | 13.3 | 16.7 | 0 | | 3.3 | 6.7 | |
| 100 ns | Index_I | | | | | | | | 8.7 |
| | XB | | | | | | | | 1.1 |
| Per-path | CH | 34.4 | 37.6 | 47.3 | 26.4 | 45.7 | 47.3 | 55.4 | 32.8 |
| AoA | DB | 0 | 0 | 8.6 | 10 | 25 | 10.2 | 11.8 | 11.8 |
| AS = 36 | CV | 34.4 | 31.2 | 40.9 | 40 | 45 | 36 | 45.7 | 29.6 |
| DS = 0 ns | Index_I | | | | | | | | 11.8 |
| | XB | | | | | | | | |
| Per-path | CH | 29.6 | 31.2 | 44.1 | 36.0 | 45.7 | 44.1 | 50.5 | 29.6 |
| AoA | DB | 0 | 0 | 0 | 15 | 5 | 8.6 | 10.2 | 0 |
| AS = 36 | CV | 31.2 | 31.2 | 37.6 | 35 | 35 | 40.9 | 44.1 | 29.6 |
| DS = | Index_I | 8.6 | | | | | | | 13.5 |
| 10 ns | XB | | | | | | | | |
| Per-path | CH | 28.0 | 29.6 | 49.0 | 24.7 | 36 | 42.5 | 57 | 37.6 |
| AoA | DB | 0 | 0 | 8.6 | 10 | 25 | 8.6 | 10.2 | 8.6 |
| AS = 36 | CV | 29.6 | 28.0 | 42.5 | 40 | 45 | 37.6 | 45.7 | 31.2 |
| DS = | Index_I | 8.6 | | | | | | | 11.8 |
| 20 ns | XB | | | | | | | | |
| Per-path | CH | 18.3 | 20.0 | 36.0 | 32.8 | 29.6 | 38 | 47.3 | 36 |
| AoA | DB | 0 | 1 | 0 | 5 | 0 | 8.6 | 10.2 | 11.8 |
| AS = 36 | CV | 18.3 | 18.3 | 26.4 | 25 | 20 | 31.2 | 39.3 | 29.6 |
| DS = | Index_I | | | | | | | | 11.8 |
| 40 ns | XB | | | | | | | | |
| Per-path | CH | 10.2 | 10.2 | 26.4 | 16.7 | 23.1 | 23.1 | 32.8 | 21.5 |
| AoA | DB | 8.6 | 0 | 0 | 5 | 0 | 8.6 | 8.6 | 8.6 |
| AS = 36 | CV | 10.2 | 8.6 | 20.0 | 15 | 10 | 16.7 | 28 | 24.7 |
| DS = | Index_I | | | | | | | | 0 |
| 100 ns | XB | | | | | | | | 0 |
| TABLE 3-3 | | | | | | | | | |
| Per-path | CH | 26.1 | 25 | 45.7 | 30.4 | 35.9 | 40.2 | 55.3 | 21.7 |
| AoA | DB | 1.1 | 1.1 | 1.1 | 3.3 | 3.3 | 6.5 | 6.5 | 5.4 |
| AS = 18 | CV | 21.7 | 20.7 | 37.0 | 26.7 | 36.7 | 31.5 | 45.7 | 30.4 |
| DS = | Dunn | | 13.3 | 16.7 | 0 | | 3.3 | 6.7 | |
| 100 ns | Index_I | | | | | | | | 8.7 |
| | XB | | | | | | | | 1.1 |
| Per-path | CH | 34.4 | 37.6 | 47.3 | 26.4 | 45.7 | 47.3 | 55.4 | 32.8 |
| AoA | DB | 0 | 0 | 8.6 | 10 | 25 | 10.2 | 11.8 | 11.8 |
| AS = 36 | CV | 34.4 | 31.2 | 40.9 | 40 | 45 | 36 | 45.7 | 29.6 |
| DS = 0 ns | Index_I | | | | | | | | 11.8 |
| | XB | | | | | | | | |
| Per-path | CH | 29.6 | 31.2 | 44.1 | 36.0 | 45.7 | 44.1 | 50.5 | 29.6 |
| AoA | DB | 0 | 0 | 0 | 15 | 5 | 8.6 | 10.2 | 0 |
| AS = 36 | CV | 31.2 | 31.2 | 37.6 | 35 | 35 | 40.9 | 44.1 | 29.6 |
| DS = | Index_I | 8.6 | | | | | | | 13.5 |
| 10 ns | XB | | | | | | | | |
| Per-path | CH | 28.0 | 29.6 | 49.0 | 24.7 | 36 | 42.5 | 57 | 37.6 |
| AoA | DB | 0 | 0 | 8.6 | 10 | 25 | 8.6 | 10.2 | 8.6 |
| AS = 36 | CV | 29.6 | 28.0 | 42.5 | 40 | 45 | 37.6 | 45.7 | 31.2 |
| DS = | Index_I | 8.6 | | | | | | | 11.8 |
| 20 ns | XB | | | | | | | | |
| Per-path | CH | 18.3 | 20.0 | 36.0 | 32.8 | 29.6 | 38 | 47.3 | 36 |
| AoA | DB | 0 | 1 | 0 | 5 | 0 | 8.6 | 10.2 | 11.8 |
| AS = 36 | CV | 18.3 | 18.3 | 26.4 | 25 | 20 | 31.2 | 39.3 | 29.6 |
| DS = | Index_I | | | | | | | | 11.8 |
| 40 ns | XB | | | | | | | | |
| Per-path | CH | 10.2 | 10.2 | 26.4 | 16.7 | 23.1 | 23.1 | 32.8 | 21.5 |
| AoA | DB | 8.6 | 0 | 0 | 5 | 0 | 8.6 | 8.6 | 8.6 |
| AS = 36 | CV | 10.2 | 8.6 | 20.0 | 15 | 10 | 16.7 | 28 | 24.7 |
| DS = | Index_I | | | | | | | | 0 |
| 100 ns | XB | | | | | | | | 0 |

In Table 3-1 through Table 3-3, the performances of the clustering validation techniques and the various clustering algorithms with respect to the change in the DS in the cluster are compared.

TABLE 4

| Per-path DS(ns) | mean cluster No. | std cluster No. |
|---|---|---|
| 0 | 5.59 | 0.88 |
| 10 | 5.54 | 1.02 |
| 20 | 5.51 | 1.00 |
| 40 | 5.43 | 1.1 |
| 100 | 5.38 | 1.23 |

In Table 4, an average and a standard deviation of the number of clusters when performing a clustering based on a KPowerMeans-AL of the present invention and a CH index are illustrated. In this instance, an angular spread is 9°.

TABLE 5

| Per-path DS(ns) | mean cluster No. | std cluster No. |
|---|---|---|
| 0 | 5.7 | 0.92 |
| 10 | 5.7 | 0.92 |
| 20 | 5.6 | 0.89 |
| 40 | 5.5 | 0.9 |
| 100 | 5.3 | 1.18 |

In Table 5, an mean is shown in Table 5] and a standard deviation of the number of clusters when performing a clustering based on the KPowerMeans-AL of the present invention and the CH index are illustrated. In this instance, an angular spread is 18°.

When an optimal number of clusters is obtained while varying a number of clusters K with respect to a 3GPP SCM data set, a proportion of a data set where the optimal number of clusters is accurately obtained as ‘kopt=6’, represented as a percentage in Table 1. The 3GPP SCM data set includes six clusters. Each simulation is performed with respect to 100 data sets.

As illustrated in Table 1, as an angular spread value in a cluster increases, a performance of algorithms is generally degraded. Also, a performance difference among the algorithms with a great angular spread is greater than in a small angular spread. An optimal performance is shown in an algorithm according to the present invention. A K-means algorithm in a conventional art has a disadvantage of a performance degradation due to an initial cluster centroid. Also, a performance difference between the KPowerMeans algorithm, providing a power weight to the K-means algorithm, and the K-means algorithm is not significant when the angular spread in the cluster is small. However, as the angular spread increases, the performance difference increases.

Table 1 illustrates only the proportion when the six clusters are accurately obtained.

However, the data set generated by the 3GPP SCM may obtain five or seven clusters, since a delay may be grouped together, angular spread in a cluster may significantly spread, or angular spread distribution between clusters may overlap.

Table 2 illustrates an average and a standard deviation obtained using the optimal number of clusters with respect to a KPowerMeans+CH index. When the six clusters are not accurately obtained, similar values may be obtained.

Performances of clustering validation techniques according to various angular spread changes and DS changes are compared in Table 3.

An optimal performance is shown in an algorithm according to the present invention in Table 3. A performance difference due to the DS changes is greater than a performance difference due to the angular spread changes in a cluster. Particularly, since an SL performs a clustering based on a closest MPC among clusters, the SL is most sensitive to the angular spread changes and DS changes, and a degradation of the SL is significant.

Also, the SL performs a clustering in a way that each MPC is serially combined from an initial cluster, and thus adjacent clusters may be recognized as a single cluster. An AL also has a same disadvantage when the angular spread and DS increase, since the AL has a basic concept of clustering identical to the SL, even though the AL has a different distance measurement method. Conversely, in a K-means algorithm, a centroid is determined according to a number of clusters first received, and is repeatedly updated, and a clustering is performed based on a cluster centroid. Accordingly, the disadvantage of the linkage algorithm may be overcome.

Thus, according to the present invention, the KPowerMeans algorithm of the present invention may overcome the disadvantage of the linkage algorithm and disadvantage of an initial cluster centroid of the K-means algorithm. A performance of the KPowerMeans algorithm of the present invention is improved in comparison to a KPowerMeans algorithm in a conventional art.

Table 4 and Table 5 illustrate an average and a standard deviation obtained using the optimal number of clusters with respect to a KPowerMeans+CH index.

The above-described embodiment of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to an embodiment of the present invention, an initial cluster centroid is set using a hierarchical clustering algorithm, and thus a performance degradation due to the initial cluster centroid may be overcome.

Also, according to an embodiment of the present invention, a great amount of data may be automatically processed.

Also, according to an embodiment of the present invention, there is provided a method and apparatus for multi-path clustering which is suitable for a wireless communication environment and superior to an existing macrography in terms of accuracy and efficiency through a validation index and optimal MCD weight with respect to various communication environments.

Also, according to an embodiment of the present invention, a standard for multi-path clustering may be provided, and a spatial channel analysis and research based on a great amount of measurement data in various communication environments may be supported.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An automatic clustering method, comprising:
a first step of obtaining an initial cluster centroid using a hierarchical clustering algorithm;
a second step of moving the initial cluster centroid using a two dimensional clustering algorithm;
a third step of clustering a data set according to the moved initial cluster centroid; and
a fourth step of calculating a validation index with respect to the clustered data set and determining an optimal number of clusters.

2. The automatic clustering method of claim 1, wherein the hierarchical clustering algorithm defines a distance between clusters as an average distance among samples in the cluster.

3. The automatic clustering method of claim 2, wherein the first step comprises:
executing a hierarchical clustering algorithm; and
obtaining the initial cluster centroid using a result of the executing.

4. The automatic clustering method of claim 1, wherein the two dimensional clustering algorithm is a KPowerMeans algorithm.

5. The automatic clustering method of claim 1, wherein the validation index is determined according to a separation of each cluster and a compactness of data in each of the clusters.

6. The automatic clustering method of claim 1, wherein the fourth step comprises:
performing the first step, second step, and third step with respect to each value from an initial value to a maximum value of a previously set number of clusters and obtaining each of the clustered data sets;
calculating a validation index with respect to each of the clustered data sets; and
determining a number of clusters when the validation index is maximum as an optimal number of clusters.

7. A method of multi-path clustering in a wireless communication environment, the method comprising:
determining a weight of a channel parameter for a distance calculation of a multi-path component;
applying the determined weight of the channel parameter to a hierarchical clustering algorithm;
calculating a centroid of a cluster using the hierarchical clustering algorithm;
setting the calculated centroid of the cluster as an initial cluster centroid and executing a KPower Means algorithm;
calculating a validation index with respect to a result of the executing; and
determining an optimal number of clusters according to the calculated validation index.

8. The method of claim 7, wherein the weight of the channel parameter has a delay scaling factor of 10 and an angular scaling factor of 0.5 when a delay, angle of arrival, and angle of departure are used as the channel parameter.

9. The method of claim 7, wherein the weight of the channel parameter has a delay scaling factor of 10 and an angular scaling factor of 0.7 when delay and angle of arrival are used as the channel parameter.

10. The method of claim 7, wherein the hierarchical clustering algorithm is an Average-linkage algorithm.

11. The method of claim 10, wherein the initial cluster centroid is obtained by using a result of the Average-linkage algorithm.

12. The method of claim 7, wherein the validation index is a Cali ski-Harabasz (CH) index.

13. An apparatus for multi-path clustering in a wireless communication environment, the apparatus comprising:
a data storage unit to store a multi-path component, channel parameter, and weight information about the channel parameter which are received via a multi-path;
a clustering algorithm execution unit to apply a hierarchical clustering algorithm with respect to the multi-path component, set an initial cluster centroid, move the initial cluster centroid using a KPowerMeans algorithm, and execute a clustering; and
a cluster number determination unit to calculate a validation index with respect to the executed clustering, and determine an optimal number of clusters based on the calculated validation index.

14. The apparatus of claim 13, wherein the weight of the channel parameter has a delay scaling factor of 10 and an angular scaling factor of 0.5 when a delay, angle of arrival, and angle of departure are used as the channel parameter.

15. The apparatus of claim 13, wherein the weight of the channel parameter has a delay scaling factor of 10 and an angular scaling factor of 0.7 when delay and angle of arrival are used as the channel parameter.
